(19) United States
(12) Patent Application Publication
(10) Pub. No.: US 2011/0042275 A1
(43) Pub. Date: Feb. 24, 2011

(54) FLAT-ARTICLE FEED DEVICE WITH A SYNCHRONIZER HAVING A PLURALITY OF MOTOR DRIVES

(75) Inventors: Stephane Samain, Chabeuil (FR); Thomas Schmitt, Saint Marcel Les Valence (FR); Damien Hugues, Valence (FR); Stephane Ambroise, Serves (FR)

Correspondence Address: SUGHRUE MION, PLLC, 2100 PENNSYLVANIA AVENUE, N.W., SUITE 800, WASHINGTON, DC, 20037, US

(73) Assignee: Solystic, Gentilly Cedex (FR)

(21) Appl. No.: 12/811,044

(22) PCT Filed: Apr. 6, 2010
(86) PCT No.: PCT/FR2010/050659

§ 371 Date: Jun. 28, 2010

(30) Foreign Application Priority Data
Apr. 9, 2009 (FR) 0952356

(51) Int. Cl. B07C 1/02; B65G 59/00

(52) U.S. Cl. 209/3.1; 414/795.4

(57) ABSTRACT

A flat-article feed device comprising an unstacker device (4), a conveyor (5) on which the unstacked articles in series and on edge are moved with constant pitch, and a synchronization device (6) interposed between the unstacker device and the conveyor so as to compensate for variations in pitch between consecutive articles. The unstacker device (4) is servo-controlled to unstack a current article in response to a signal indicating detection of the passage of another unstacked article preceding said current article downstream from the unstacker. The synchronization device (6) is arranged to move a plurality of articles at the same time in series and on edge with different respective speed profiles in order to compensate for variations in pitch.

The invention relates to a flat-article feed device comprising an unstacker device for unstacking flat articles, a conveyor for moving the unstacked articles in series and on edge with constant pitch between two consecutive articles, and a synchronization device interposed between the unstacker device and the conveyor and in which each unstacked article is moved with a certain speed profile so as to compensate for variations in pitch between consecutive articles. More particularly, the invention relates to a postal sorting machine including such a feed device that may serve to sort mailpieces into a bin carrousel.

Patent Document FR-2 797 437 discloses such a feed device in which the synchronization device is arranged with three stages of trains of wheels driven by a single motor drive. At the outlet of the conveyor, the mailpieces in series and on edge that are spaced apart at constant pitch are injected into the bins of a bin carrousel. A typical throughput rate for such a sorting machine is 3 articles per second. The unstacker device and the synchronization device are tied synchronously to the time frame of the bins of the carrousel as described in Patent Document FR-2 906 235.

An object of the invention is to propose a feed device that operates with a high throughput rate, in particular so as to double the throughput rate of a sorting machine as presented above while modifying such a machine little.

The basic idea of the invention is to bring the mailpieces in the conveyor closer together by reducing the constant pitch between consecutive articles.

To this end, the invention provides a flat-article feed device comprising an unstacker device for unstacking flat articles, a conveyor for moving the unstacked articles in series and on edge with constant pitch between two consecutive articles, and a synchronization device interposed between the unstacker device and the conveyor and in which each unstacked article is moved with a certain speed profile so as to compensate for variations in pitch between consecutive articles, said flat-article feed device being characterized in that the unstacker device is servo-controlled to unstack a current flat article in response to a signal indicating detection of the passage of another unstacked flat article preceding said current flat article downstream from the unstacker, and in that the synchronization device is arranged to move a plurality of flat articles at the same time in series and on edge with different respective speed profiles in order to compensate for variations in pitch.

With such a feed device, the same conveyor is used as in the state of the art, but the unstacker has accelerated operation and the differences in pitch between consecutive mailpieces are compensated in a synchronization device of compactness that remains unchanged compared with the reference state of the art.

The feed device of the invention may also have the following characteristics:
it further comprises a passage sensor disposed between the unstacker device and the synchronization device for delivering a servo-control signal to the unstacker device;
the synchronization device comprises a plurality of stages of trains of wheels having elastically deformable rims, the wheel trains having respective motor drives that are independent from one another so as to move a plurality of flat articles at the same time with different speed profiles; and
the wheel trains of the various stages are disposed so that they overlap one another.

The invention can be understood more clearly on reading the following description with reference to the drawing. This description is given merely by way of indication and in no way limits the invention. In the drawing:

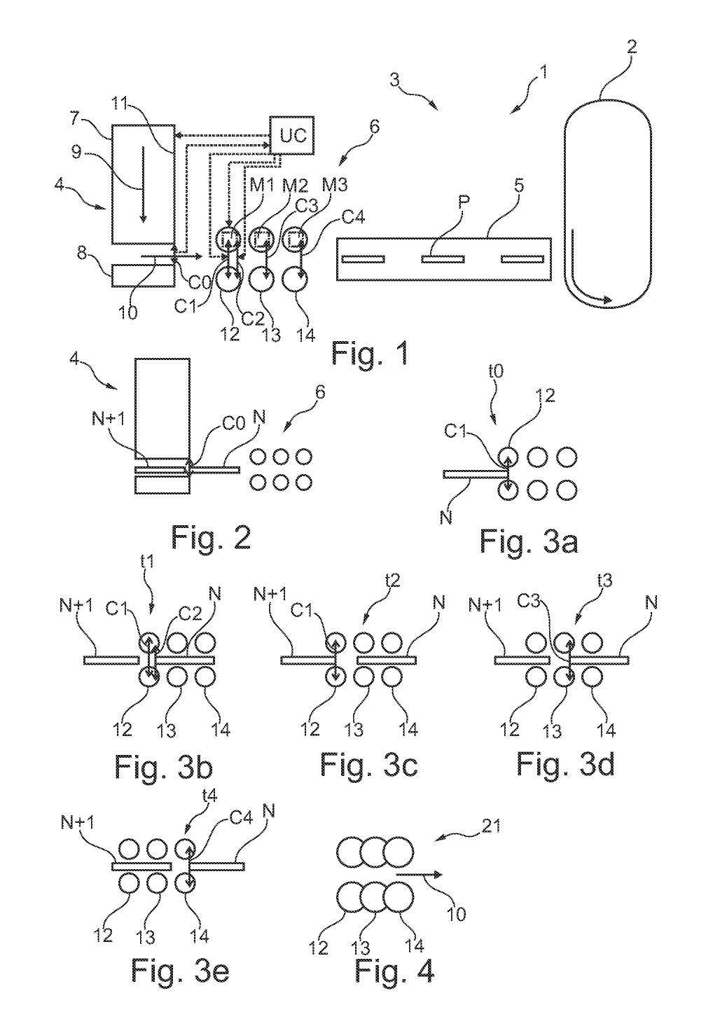

FIG. 1 is a diagrammatic plan view of a sorting machine equipped with the feed device of the invention;

FIG. 2 is a diagrammatic plan view of the synchronization device with trains of wheels;

FIGS. 3a-3e diagrammatically show how the synchronization device operates; and

FIG. 4 shows a variant of the synchronization device of the invention with trains of wheels that overlap.

FIG. 1 shows a feed device 1 of the invention that constitutes the inlet of a postal sorting machine 3 provided with a bin carrousel 2.

The bins (not shown) of the carrousel follow a closed-loop path for directing mailpieces (letters, parcels, or other flat articles) above sorting outlet trays, as is well known.

The feed device 1 comprises an unstacker device 4 for putting mailpieces P disposed in a stack into series, and a conveyor 5 on which the unstacked mailpieces are moved on edge and in series towards a point of injection into the bins of the carrousel 2.

On the conveyor 5, the mailpieces are spaced apart at constant pitch between mailpieces in each pair. In this example, the pitch is the distance between the leading edges of two consecutive mailpieces. This pitch must be constant so that the mailpieces in series on the conveyor 5 arrive at the point of injection synchronously with the bins of the carrousel.

In the invention, the feed device further comprises a synchronization device 6 interposed between the unstacker device 4 and the conveyor 5 so as to make up for the variations in said pitch between consecutive mailpieces.

Thus, in conventional manner, the unstacker device 4 comprises a magazine 7 in which the mailpieces are stored in a stack and on edge, an unstacking plate 8 on which the first mailpiece in the stack is separated from the stack by being moved perpendicularly to the direction of movement of the stack that is indicated by arrow 9. For this purpose, the unstacking plate 8 is equipped with a perforated belt co-operating with suction nozzles (not shown), the belt moving over the plate 8 in the direction indicated by arrow 10.

In this machine, the bins move along the closed path at constant speed. The conveyor 5 also moves the mailpieces at constant speed, e.g. at a speed of 3.15 meters per second (m/s).

In the invention, the fact that the unstacker 4 operates asynchronously relative to the carrousel 2 is used to reduce to as small as possible the pitch between consecutive mailpieces on the conveyor 5 so as to obtain a sorting machine having a throughput rate of about 6 mailpieces per second, which corresponds to a constant pitch of 166 milliseconds (ms). In addition, a synchronization device 6 is used that has only three stages of trains of wheels but in which each train of wheels is motor-driven independently relative to the other trains of wheels in a manner such that two mailpieces can be moved through the device 6 with two different speed profiles.

Servo-control of the unstacker 4 for causing the unstacking to take place early is based on a signal delivered by a passage sensor C0 that is in alignment with and downstream from a jogger edge 11 of the magazine 7. The passage sensor C0 is thus placed between the feed device 4 and the synchronization device 6 along the path of the mailpieces.

In practice, the sensor C0 is connected to a control unit UC, itself controlling operation of the unstacker device 4. The control unit UC monitors the signal generated by the sensor C0 for detecting the passage of the trailing edge of a mailpiece, this detection serving as a servo-control signal for the unstacker 4. Therefore, in the invention, the unstacker 4 operates asynchronously relative to the carrousel 2.

At the outlet of the unstacker 4, the mailpieces are thus not in series at constant pitch but the gaps between them are substantially constant, and the synchronization device 6 must thus synchronize the consecutive mailpieces at constant pitch.

In this example, this device 6 has three stages of trains of wheels 12, 13, 14, each wheel train stage comprising two wheels (or two superposed sets of wheels), each mailpiece being moved on edge by being nipped between the two facing wheels. These three wheel train stages have independent motor drives, thereby making it possible for the device 6 to move two mailpieces at the same time with two different speed profiles.

It should be noted that, at the outlet of the synchronization device 6, each mailpiece has a speed identical to the speed of the conveyor 5, and that the speed of the train of wheels at the back in the direction 10 of the device 6 must be slightly greater than the outlet speed of a mailpiece coming from the unstacker 4 in order to avoid damaging the mailpieces.

In FIG. 1, the independent motor drives of the three wheel train stages are referenced M1, M2, and M3. Each motor drive is controlled by the unit UC. For reasons of clarity, only the connection between the unit UC and the motor drive M1 is shown in dashed lines in FIG. 1. In order to monitor the movement of each mailpiece through the device 6 in the direction 10, the unit UC uses passage sensors C1, C2, C3, and C4 distributed along the wheel train stages. For reasons of clarity, only the connections between the unit UC and the sensors C1 and C2 are shown in FIG. 1.

The passage sensor C1 is disposed at the first wheel train stage 12 in the direction 10 for the purpose of detecting the passage of the leading edge of each mailpiece into said wheel train stage 12.

The passage sensors C2, C3, and C4 are disposed at respective ones of the three wheel train stages 12, 13, and 14 for detecting every time the trailing edge of a mailpiece goes past.

When the unit UC detects that the trailing edge of a mailpiece is going past the sensor C2, that indicates that said mailpiece has just left the wheel train stage 12. When the unit UC detects that the rear edge of a mailpiece is going past the sensor C3, that indicates that said mailpiece has just left the wheel train stage 13. And when the unit UC detects that the trailing edge of a mailpiece is going past the sensor C4, that indicates that said mailpiece has just left the wheel train stage 14.

The wheels of the synchronization device 6 are more particularly wheels having elastically deformable rims mounted on stationary axles. The conveyor 5 may be a conventional belt conveyor.

In operation, a mailpiece N is unstacked and its trailing edge is detected by the passage sensor C0. Whereupon, the unit UC causes the stacker to perform another unstacking operation on the mailpiece N+1 that is still stored in the magazine of the unstacker. The sensor C0 may be close to the outlet of the unstacker 4 so that the mailpiece N+1 is unstacked early (compared with unstacking synchronized on the carrousel 2) and the gap between these two consecutively unstacked mailpieces, when they are both in the synchronization device 6, may be small, thereby contributing to obtaining a high throughput rate for the machine.

It can be understood that control of the motor drives M1, M2, M3 by the unit UC must take account, in real time, of the position of each mailpiece in the wheel train stages, this position being given by the sensors C1 to C4.

FIGS. 3a to 3e show how the control of the wheel train stages operates.

At instant t0 in FIG. 3a, the passage of the leading edge of the mailpiece N is detected by the sensor C1. The mailpiece reaches the inlet of the first wheel train stage 12. The unit UC then computes a speed profile to be applied to the mailpiece N so that its arrival at the downstream end of the conveyor 5 corresponds to the arrival of an available bin of the carrousel 2. This speed profile determines the setpoints that the unit UC delivers to the motor drives M1 to M3. The speed profile computed by the unit UC corresponds, in particular, to a succession of speed setpoints to be applied to the motor drives M1 to M3, which setpoints result, in practice, in each mailpiece undergoing an acceleration phase followed by a deceleration phase, or the reverse, until a constant speed is reached that is the speed of the conveyor 5.

In FIG. 3b, at instant t1, the mailpiece N leaves the wheel train stage 12 whereas the mailpiece N+1 has just been unstacked and is arriving at the inlet of the wheel train stage 12. Generally, the servo-control of the unstacker device may be arranged so as to inhibit triggering of unstacking so long as the sensor C0 is masked, e.g. if the preceding mailpiece has not exited completely from the unstacker device. In addition, provision may be made for unstacking of the mailpiece N+1 to be dependent on the presence of a free bin in the carrousel for receiving said mailpiece. The passage of the trailing edge of the mailpiece N is detected by the sensor C2, and the unit UC then causes the motor drive of the stage 12 to operate so as to reduce the speed of the wheels to a reception speed corresponding substantially to the speed of the mailpieces at the outlet of the unstacker. As the mailpiece N moves through the stages of the device 6, the stages 13 and 14 are caused to operate by the unit UC on the basis of the speed profile determined for said mailpiece.

In FIG. 3c, at instant t2, the mailpiece N+1 has now reached the inlet of the wheel train stage 12. The leading edge of the mailpiece N+1 is detected by the sensor C1. The unit UC then computes a speed profile for said mailpiece N+1 that may be different from the speed profile of the mailpiece N. The speed profile for the mailpiece N+1 is then applied by the unit UC to the wheel train stage 12, while another speed profile for the mailpiece N is applied at the same time to the wheel train stages 13 and 14.

In FIG. 3d, at the instant t3, the mailpiece N leaves the wheel train stage 13 and the sensor C3 detects the passage of the trailing edge of the mailpiece N. The unit UC then causes the motor drive of the wheel train stage 13 to operate for the purpose of returning rapidly towards a speed setpoint corresponding to the speed profile for the mailpiece N+1.

In FIG. 3e, at instant t4, the mailpiece N is leaving the wheel train stage 14, and the mailpiece N+1 is nipped in the wheel train stages 12 and 13. The mailpiece N is exiting from the synchronization device 6. At this time, the speed of movement in the wheel train stage 13 has caught up with the speed setpoint assigned to the mailpiece N+1 so that the wheel train stages 12 and 13 are now moving the mailpiece N+1 with the same speed setpoint.

The passage of the trailing edge of the mailpiece N is detected by the sensor C4 and the control unit UC responds by causing the motor drive of the wheel train stage 14 to operate so as to go over rapidly from the speed setpoint assigned to the mailpiece N to the speed setpoint assigned to the mailpiece N+1. The mailpiece N is now being moved on the conveyor 5 at the conveying speed of 3.15 m/s.

FIG. 4 shows a variant of the synchronization device, in which the wheel trains are disposed in a configuration 21 that corresponds to the wheel trains overlapping one another. This configuration makes it possible to bring the nip points of each wheel train stage closer together in order to manipulate short mailpieces. Naturally, this synchronization device still has three wheel train stages with three motor drives (and thus three variable-speed drives) controlled independently from one another so that a mailpiece can be moved with a certain speed profile while another mailpiece is still engaged in the wheel train stages.

Naturally, the synchronization device may have a different number of wheel train stages without going beyond the ambit of the invention.

1. A flat-article feed device comprising an unstacker device (4) for unstacking flat articles (P), a conveyor (5) for moving the unstacked articles in series and on edge with constant pitch between two consecutive articles, and a synchronization device (6) interposed between the unstacker device and the conveyor and in which each unstacked article is moved with a certain speed profile so as to compensate for variations in pitch between consecutive articles, said flat-article feed device being characterized in that the unstacker device (4) is servo-controlled to unstack a current flat article in response to a signal indicating detection of the passage of another unstacked flat article preceding said current flat article downstream from the unstacker, and in that the synchronization device (6) is arranged to move a plurality of flat articles at the same time in series and on edge with different respective speed profiles in order to compensate for variations in pitch.

2. A feed device according to claim 1, characterized in that it further comprises a passage sensor (C0) disposed between the unstacker device (4) and the synchronization device (6) for delivering a servo-control signal to the unstacker device.

3. A feed device according to claim 1, wherein the synchronization device comprises a plurality of stages (22, 23, 24) of trains of wheels having elastically deformable rims, the wheel trains having respective motor drives (M1, M2, M3) that are independent from one another so as to move a plurality of flat articles at the same time with different speed profiles.

4. A feed device according to claim 3, wherein the wheel trains of the various stages are disposed so that they overlap one another.

5. A postal sorting machine including a feed device (1) according to claim 1.
